(19) United States
(12) Patent Application Publication
(10) Pub. No.: US 2011/0024242 A1
(43) Pub. Date: Feb. 3, 2011

(54) ELECTRO-HYDRAULIC BRAKE SYSTEM

(75) Inventors: I Jin Yang, Gyeonggi-do (KR); Seong Ho Choi, Gyunggi-do (KR)

Correspondence Address: MCDERMOTT WILL & EMERY LLP, 600 13TH STREET, N.W., WASHINGTON, DC, 20005-3096, US

(73) Assignee: MANDO CORPORATION

(21) Appl. No.: 12/846,308

(22) Filed: Jul. 29, 2010

(30) Foreign Application Priority Data
Jul. 29, 2009 (KR) 10-2009-69423

(51) Int. Cl. B60T 11/16; B60T 7/04; B60T 8/34; B60L 7/10; B60T 8/176; B60T 8/1755; B60T 13/74; B60T 13/66

(52) U.S. Cl. 188/106 P; 188/354

(57) ABSTRACT

Disclosed herein is an electro-hydraulic brake system. The electro-hydraulic brake system includes a master cylinder having a first cylinder and a second cylinder, a hydraulic power unit to supply brake oil into the respective first and second cylinders, and a first wheel and a second wheel connected respectively to the first cylinder and the second cylinder. The first wheel and the second wheel are independently controlled by hydraulic pressure generated in the first cylinder and the second cylinder.

### CROSS-REFERENCE TO RELATED APPLICATION

This application claims the benefit of Korean Patent Application No. 2009-0069423, filed on Jul. 29, 2009 in the Korean Intellectual Property Office, the disclosure of which is incorporated herein by reference.

### BACKGROUND

1. Field

Embodiments of the present invention relate to an electro-hydraulic brake system to control hydraulic brake force according to a change in regenerative brake force.

2. Description of the Related Art

A hybrid electric vehicle includes more than one power source, such as an electric motor (drive motor) and an internal combustion engine, and selectively uses power of the engine or the electric motor according to the load and velocity of the vehicle. The motor also functions to convert the remaining energy into electric energy. Thus, the hybrid electric vehicle may achieve high fuel efficiency and low environmental pollution.

In the above described hybrid electric vehicle, drive wheels of the vehicle are rotated by the electric motor that is operated by electric energy during traveling. In this case, the utilization efficiency of electric energy in the electric motor may be very important. To this end, if a vehicle driver commands deceleration or braking, the electric motor functions as a generator to generate electric energy. The generated electric energy is stored in a capacitor. While the electric motor functions as a generator, brake force is applied to the wheels of the vehicle. This is referred to as regenerative braking. In conclusion, the brake force applied to the wheels is the sum of regenerative brake force generated by the electric motor and hydraulic brake force generated by a hydraulic mechanism.

In other words, driver requested braking may be satisfied by generating only the hydraulic brake force that corresponds to a difference between the regenerative brake force generated by the electric motor and brake force demanded by the driver.

### SUMMARY

Therefore, it is an aspect of the present invention to provide an electro-hydraulic brake system in which a master cylinder is partitioned to define independently controllable hydraulic power units for control of hydraulic brake force.

Additional aspects of the invention will be set forth in part in the description which follows and, in part, will be obvious from the description, or may be learned by practice of the invention.

In accordance with an aspect of the present invention, an electro-hydraulic brake system includes a master cylinder having a first cylinder and a second cylinder, a hydraulic power unit to supply oil into the respective first and second cylinders, and a first wheel and a second wheel connected respectively to the first cylinder and the second cylinder, wherein the first wheel and the second wheel are independently controlled by hydraulic pressure generated in the first cylinder and the second cylinder.

The first cylinder and the second cylinder may be arranged in a row.

The electro-hydraulic brake system may further include a pedal simulator to provide tactile feedback to a driver through a pedal, and the pedal simulator may be integrated with any one of the master cylinder and the hydraulic power unit.

A Hydraulic Control Unit (HCU) may be provided between the first and second cylinders and the first and second wheels.

The hydraulic power unit may include a high-pressure accumulator, a first power inlet valve and a first power outlet valve to control oil transmitted from the high-pressure accumulator to the first cylinder, and a second power inlet valve and a second power outlet valve to control oil transmitted from the high-pressure accumulator to the second cylinder.

The electro-hydraulic brake system may further include a first pressure sensor provided at an entrance of the first cylinder to measure oil pressure, a second pressure sensor provided at an entrance of the second cylinder to measure oil pressure, and a third pressure sensor provided at an exit of the high-pressure accumulator to measure oil pressure.

The electro-hydraulic brake system may further include a pedal simulator hydraulically connected to the master cylinder to provide tactile feedback to a driver through a pedal, and a mode switching path provided between the pedal simulator and the hydraulic power unit, and a mode switching valve provided on a position of the mode switching path, and during normal braking, the mode switching valve is kept in a closed state such that pedal force of a driver is used to operate the pedal simulator, and during emergency braking, the mode switching valve is kept in an open state such that the pedal simulator is not operated.

The electro-hydraulic brake system may further include an input member mechanically connectable to the master cylinder, and during normal braking, pedal force of a driver is not transmitted to the master cylinder, and during emergency braking, the pedal force of the driver is transmitted to the master cylinder via the input member.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a hydraulic circuit diagram illustrating a non-braking mode of an electro-hydraulic brake system in accordance with an embodiment of the present invention;

FIG. 2 is a hydraulic circuit diagram illustrating a braking mode of the electro-hydraulic brake system in accordance with the embodiment of the present invention under normal operation of the system; and

FIG. 3 is a hydraulic circuit diagram illustrating a braking mode of the electro-hydraulic brake system in accordance with the embodiment of the present invention under abnormal operation of the system.

### DETAILED DESCRIPTION

Reference will now be made in detail to the embodiments of the present invention, examples of which are illustrated in the accompanying drawings, wherein like reference numerals refer to like elements throughout.

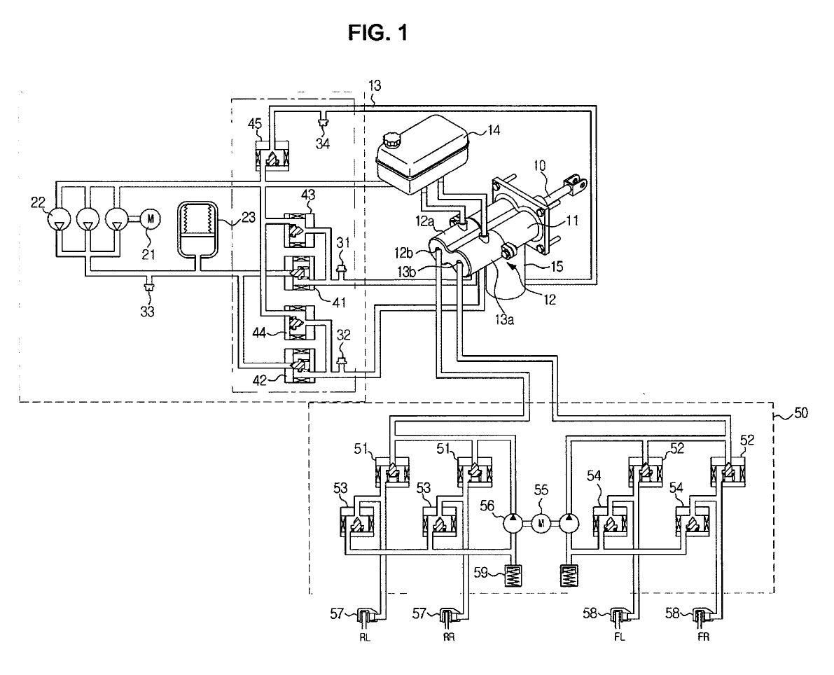

FIG. 1 is a hydraulic circuit diagram illustrating a non-braking mode of an electro-hydraulic brake system in accordance with the embodiment of the present invention.

Referring to FIG. 1, the electro-hydraulic brake system (hereinafter, referred to as “EHB” system) in accordance with the embodiment may include a hydraulic power unit 11 to increase force transmitted from a brake input member 10 at a constant rate, the brake input member 10 being connected to a brake pedal (not shown) that is operated by a driver upon braking, a master cylinder 12 connected to the hydraulic power unit 11, a reservoir 14 located above the master cylinder 12 to store oil therein, wheel cylinders 57 and 58 to perform braking of respective wheels RR, RL, FR and FL, and a hydraulic control unit 50 (hereinafter, referred to as “HCU”) provided between the master cylinder 12 and the wheel cylinders 57 and 58.

The driver may decelerate or stop a traveling vehicle by pressing the brake pedal 10.

The hydraulic power unit 11 may include a motor 21, pump 22, high-pressure accumulator 23, four pressure sensors 31, 32, 33 and 34 and five solenoid valves 41, 42, 43, 44 and 45. The hydraulic power unit 11 may create hydraulic brake force based on brake force demanded by the driver. That is, the master cylinder 12 may be boosted to provide hydraulic brake force corresponding to a difference between regenerative brake force and the brake force demanded by the driver.

The pump 22 functions to pump the oil transmitted from the reservoir 14 at a high pressure to create brake pressure. To this end, the motor 21 is connected to the pump 22 to provide the pump 22 with drive power.

The high-pressure accumulator 23 is provided at an exit side of the pump 22. The high-pressure accumulator 23 may temporarily store high-pressure oil generated by operation of the pump 22, and may transmit hydraulic pressure to the mater cylinder 12 upon braking. The hydraulic pressure of the high-pressure accumulator 23 is introduced into a first cylinder 12a of the master cylinder 12 through a first power inlet valve 41, and is introduced into a second cylinder 13a of the master cylinder 12 through a second power inlet valve 42. A third pressure sensor 33 is provided at an exit side of the high-pressure accumulator 23 to measure the pressure of oil from the high-pressure accumulator 23.

The reservoir 14 to store oil therein may be installed to the master cylinder 12. The master cylinder 12 may include the first cylinder 12a and second cylinder 13a, which may be completely independently operated. The first cylinder 12a and second cylinder 13a are provided respectively with a first exit 12b and second exit 13b, through which the oil is discharged into the HCU 50.

A first pressure sensor 31 may be installed between the first power inlet valve 41 and the first cylinder 12a to measure the hydraulic pressure applied to the first cylinder 12a. A second pressure sensor 32 may be installed between the second power inlet valve 42 and the second cylinder 13a to measure the hydraulic pressure applied to the second cylinder 13a.

Information provided by the first pressure sensor 31 and second pressure sensor 32 may be used to determine whether or not pressure applied to the first cylinder 12a and second cylinder 13a is appropriate. That is, these pressure sensors 31 and 32 may be used to provide the first cylinder 12a and second cylinder 13a with accurate pressure. For example, the opening rate of the first power inlet valve 41 may be regulated according to a signal from the first pressure sensor 31, to provide the first cylinder 12a with appropriate boosting hydraulic pressure. Also, the opening rate of the second power inlet valve 42 may be regulated according to a signal from the second pressure sensor 31, to provide the second cylinder 13a with appropriate boosting hydraulic pressure.

The first cylinder 12a and second cylinder 13a may provide the respective wheel cylinders 57 and 57 with desired hydraulic brake force, enabling independent control of the rear wheels RL and RR or the front wheels FL and FR without changing the configuration of the HCU 50. Specifically, the hydraulic brake force provided by the first cylinder 12a is transmitted to the rear wheel cylinders 57 to control the rear wheels RL and RR, and the hydraulic brake force provided by the second cylinder 13a is transmitted to the front wheel cylinders 58 to control the front wheels FL and FR.

The HCU 50 may take the form of a standard Anti-lock Brake System (ABS). The HCU 50 may include a pump 56, motor 55, accumulator 59, and the like. As described above, the HCU 50 may control the rear wheels RL and RR or the front wheels FL and FR without any change in configuration. For example, the first cylinder 12a of the master cylinder 12 may be connected to the rear wheel cylinders 57 to control the rear wheels RL and RR, and the second cylinder 13a of the master cylinder 12 may be connected to the front wheel cylinders 58 to control the front wheels FL and FR.

The pump 56, motor 55 and accumulator 59 may be identical to those of a conventional HCU system.

A first inlet valve 51 is of a normal close type and is normally kept in a closed state. The first inlet valve 51 is opened when the driver pushes the brake pedal, allowing the brake oil transmitted from the first cylinder 12a to be transmitted to the corresponding rear wheel cylinder 57. The second inlet valve 52 is also of a normal close type and is normally kept in a closed state. The second inlet valve 52 is opened when the driver pushes the brake pedal, allowing the brake oil transmitted from the second cylinder 13a to be transmitted to the corresponding front wheel cylinder 58.

A first outlet valve 53 and second outlet valve 54 are of normal open type and are normally kept in an open state. The first outlet valve 53 and second outlet valve 54 are closed when the driver pushes the brake pedal and thereafter, are opened when the driver releases the brake pedal, allowing discharge of the oil from the wheel cylinders 57 and 58.

The hydraulic power unit 11 may be provided with a mode switching path 13 that is used upon breakdown of the EHB system. The mode switching path 13 may be provided with a mode switching valve 45 to open or close the mode switching path 13. The mode switching valve 45 is of a normal open type and may function to intercept the mode switching path 13 during normal braking and to open the mode switching path 13 during emergency braking.

A pedal simulator 15 may be hydraulically connected between the brake input member 10 and the master cylinder 12. The pedal simulator 15 may be integrated with the hydraulic power unit 11, or may be integrated with the master cylinder 12. A fourth pressure sensor 34 may be provided on the mode switching path 13 connected to the pedal simulator 15 to measure the pressure of oil.

During driver requested braking, the mode switching valve 45 may intercept the mode switching path 13, the pedal simulator 15 may provide tactile feedback to the driver through the pedal, and information provided by the fourth pressure sensor 34 may be used to determine brake force demanded by the driver.

In the EHB system in accordance with the embodiment of the present invention, the simulator to create the pedal force as well as the motor, pump, accumulator, various valves and sensors are integrated with the master cylinder 12 or the hydraulic power unit 11 and therefore, an HCU having a simulator only for the EHB system may be unnecessary. In this way, any generalized HCU may be used.

Hereinafter, operation of the EHB system in accordance with the embodiment of the present invention will be described in detail.

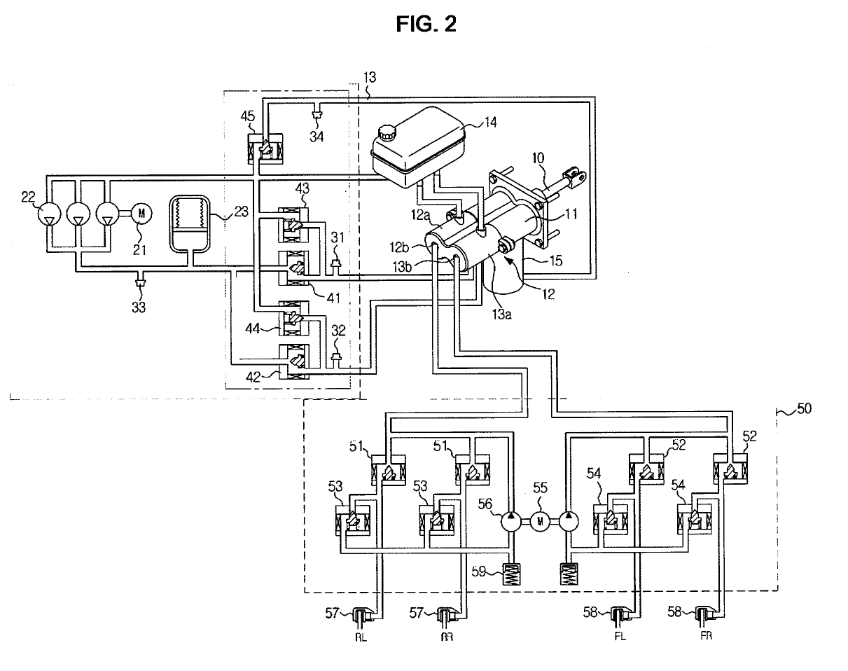

FIG. 2 is a hydraulic circuit diagram illustrating a braking mode of the EHB system under normal operation of the system.

Referring to FIG. 2, if the driver pushes the brake pedal, the mode switching valve 45 may be closed. The pedal force applied by the driver is used to operate the pedal simulator 15, thus providing tactile feedback to the driver through the pedal. In addition, brake force demanded by the driver may be sensed based on information provided by the fourth pressure sensor 34, such as the pedal force, etc.

The magnitude of regenerative brake force may be input into a control unit (not shown). The control unit may calculate the magnitude of frictional brake force corresponding to a difference between the brake force demanded by the driver and the regenerative brake force, and consequently, may determine the magnitude of increased or decreased pressure at the wheels.

Specifically, if the driver pushes the brake pedal (not shown) at an initial braking stage, the vehicle is sufficiently braked by the regenerative brake force and thus, may be controlled to generate no frictional brake force. It may be necessary to reduce the pressure of brake oil to prevent the hydraulic pressure of the first cylinder 12a and second cylinder 13a from being transmitted to the rear wheel cylinders 57 and front wheel cylinders 58. In this case, the first and second outlet valves 53 and 54 are opened to transmit the brake oil into the accumulator 59, so as to prevent transmission of pressure to the wheels RR, RL, FR and FL while continuously maintaining brake pedal pressure.

Thereafter, an operation of regulating the frictional brake force according to a change in the regenerative brake force may be performed. The regenerative brake force is changed according to the charging rate of a battery or the velocity of the vehicle. For example, the regenerative brake force exhibits a rapid decrease below a predetermined velocity. To deal with this situation, it may be necessary to increase the frictional brake force. The control unit may increase or decrease boosting power applied to the first cylinder 12a by controlling the first power inlet valve 41 and first power outlet valve 45 to, and may increase or decrease boosting power applied to the second cylinder 13a by controlling the second power inlet valve 42 and second power outlet valve 44. Thereafter, the control unit may increase or decrease the flow rate of oil transmitted to the rear wheel cylinders 57 according to an increase or decrease in the hydraulic pressure of the first cylinder 12a, and may increase or decrease the flow rate of oil transmitted to the front wheel cylinders 58 according to an increase or decrease in the hydraulic pressure of the second cylinder 13a.

Thereafter, if no regenerative brake force is generated, hydraulic brake force equal to brake force demanded by the driver may be generated. In this case, the hydraulic power unit 11 may generate hydraulic brake force in the first cylinder 12a and second cylinder 13a respectively, to transmit the hydraulic brake force to the wheels.

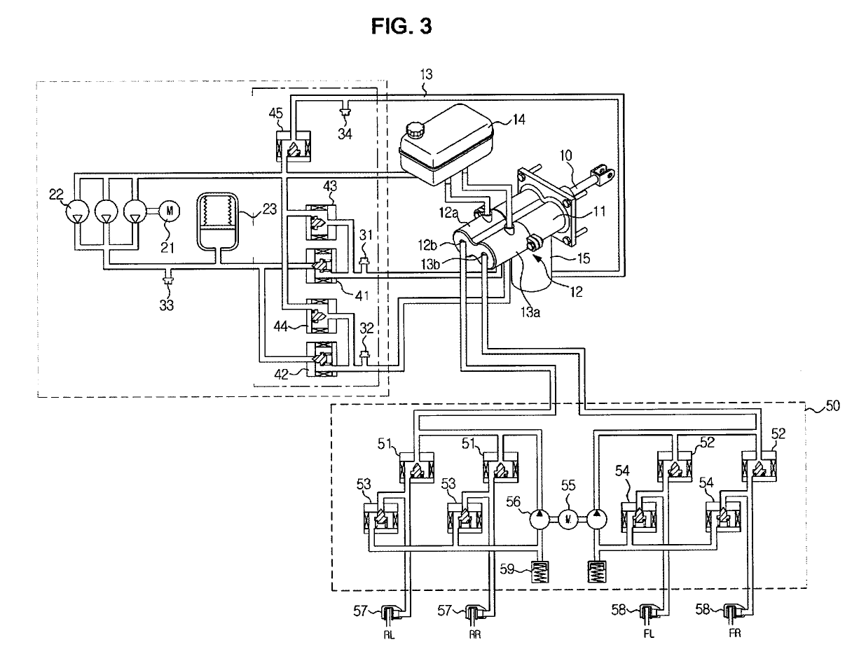

FIG. 3 is a hydraulic circuit diagram illustrating a braking mode of the EHB system under abnormal operation of the system.

Referring to FIG. 3, a system for emergency braking may be provided upon abnormal operation of the EHB system. That is, the driver may mechanically apply hydraulic pressure to the wheels by use of the pedal force.

Upon emergency braking, i.e. when the hydraulic power unit 11 or the control unit breaks down, the mode switching valve 45 may be kept in an open state. In this case, the pedal simulator 15 does not generate tactile feedback even if the driver pushes the brake pedal. Thus, the overall pedal force may be transmitted to the brake input member 10. Thereafter, the hydraulic pressure generated in the first cylinder 12a and second cylinder 13a by forward movement of the input member 10 may be transmitted to the wheel cylinders 57 and 58, thereby providing the front wheels FL and FR and the rear wheels RL and RR with brake force.

As is apparent from the above description, in an EHB system in accordance with an embodiment of the present invention, a master cylinder is designed to enable individual pressure control, and thus, pressure required for regenerative braking may be easily controlled.

Further, the system is constructed without changing the configuration of a conventional ABS system and thus, may perform regenerative braking control, Anti-lock Brake System (ABS) control and Electronic Stability Control (ESC).

Furthermore, the EHB system may be easily mounted in a vehicle, thus achieving cost reduction.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electro-hydraulic brake system comprising:
a master cylinder having a first cylinder and a second cylinder;
a hydraulic power unit to supply oil into the respective first and second cylinders; and
a first wheel and a second wheel connected respectively to the first cylinder and the second cylinder,
wherein the first wheel and the second wheel are independently controlled by hydraulic pressure generated in the first cylinder and the second cylinder.

2. The system according to claim 1, wherein the first cylinder and the second cylinder are arranged in a row.

3. The system according to claim 1, further comprising:
a pedal simulator to provide tactile feedback to a driver through a pedal,
wherein the pedal simulator is integrated with any one of the master cylinder and the hydraulic power unit.

4. The system according to claim 1, wherein a Hydraulic Control Unit (HCU) is provided between the first and second cylinders and the first and second wheels.

5. The system according to claim 1, wherein the hydraulic power unit includes: a high-pressure accumulator; a first power inlet valve and a first power outlet valve to control oil transmitted from the high-pressure accumulator to the first cylinder; and a second power inlet valve and a second power outlet valve to control oil transmitted from the high-pressure accumulator to the second cylinder.

6. The system according to claim 5, further comprising:
a first pressure sensor provided at an entrance of the first cylinder to measure oil pressure;
a second pressure sensor provided at an entrance of the second cylinder to measure oil pressure; and
a third pressure sensor provided at an exit of the high-pressure accumulator to measure oil pressure.

7. The system according to claim 1, further comprising:
a pedal simulator hydraulically connected to the master cylinder to provide tactile feedback to a driver through a pedal; and
a mode switching path provided between the pedal simulator and the hydraulic power unit; and
a mode switching valve provided on a position of the mode switching path,
wherein during normal braking, the mode switching valve is kept in a closed state such that pedal force of a driver is used to operate the pedal simulator, and during emergency braking, the mode switching valve is kept in an open state such that the pedal simulator is not operated.

8. The system according to claim 1, further comprising an input member mechanically connectable to the master cylinder,
wherein during normal braking, pedal force of a driver is not transmitted to the master cylinder, and during emergency braking, the pedal force of the driver is transmitted to the master cylinder via the input member.
